(19) United States
(12) Patent Application Publication
(10) Pub. No.: US 2025/0392341 A1
(43) Pub. Date: Dec. 25, 2025

(54) COMMUNICATING THROUGH RADAR

(71) Applicant: InnoTech Systems LLC, La Crescenta, CA (US)

(72) Inventors: Fereydoun Fred Daneshgaran, La Crescenta, CA (US); Khashayar Olia, Mountain View, CA (US)

(21) Appl. No.: 19/245,104

(22) Filed: Jun. 20, 2025

Related U.S. Application Data
(60) Provisional application No. 63/662,804, filed on Jun. 21, 2024.
(60) Provisional application No. 63/662,810, filed on Jun. 21, 2024.

(51) Int. Cl. H04B 1/40; G01S 13/87; G01S 13/88

(52) U.S. Cl. CPC H04B 1/40; G01S 13/87; G01S 13/88

(57) ABSTRACT

A communication system including a RADAR transceiver configured to be implemented in a first apparatus, a transponder configured to be implemented in a second apparatus, the first apparatus and the second apparatus configured to communicate via a method of communication. The method comprising sending, via the RADAR transceiver, a signal for detection of the transponder, receiving, via the transponder, the signal, generating, via the transponder, a response to the signal, the response including embedded information, sending, via the transponder, the response to the RADAR transceiver, receiving, via the RADAR transceiver, the response and extracting the embedded information, and executing, via the RADAR transceiver, one or more actions based at least in part on the embedded information.

### CROSS-REFERENCE TO RELATED APPLICATIONS

This application claims priority from U.S. Provisional Application No. 63/662,804, filed on Jun. 21, 2024, and U.S. Provisional Application No. 63/662,810, also filed on Jun. 21, 2024, the entire disclosures of which are incorporated herein by reference and for all purposes.

### BACKGROUND

Next-Gen sensing and communication technology are instrumental for enabling many advanced automotive and autonomous system technologies such as Cooperative Driving Automation (CDA). Currently, there appear to be few, if any, viable options for communication between vehicles and other vehicles, devices, or infrastructure in the surrounding environment. It is desirable to use existing automotive sensors designed and deployed for a different purpose to enable communications among vehicles and between vehicles and infrastructure.

### BRIEF DESCRIPTION OF THE DRAWINGS

FIG. 1 illustrates some of the frequency bands for operation of modern automotive RAdio Detection And Ranging (RADAR).

FIG. 2 illustrates a front, side view of a first vehicle, and a rear, side view of a second vehicle, according to an embodiment of this disclosure.

FIG. 3 illustrates a chart illustrating the power spectrum for three examples of line codes (e.g., polar, bipolar Alternate Mark Inversion, and split phase or Manchester encoding), according to an embodiment of this disclosure.

FIG. 4 illustrates a block diagram for signal processing, according to an embodiment of this disclosure.

FIG. 5 illustrates a block diagram illustrating a data detection/extraction process that uses a Quadrature Mixing Technique, according to an embodiment of this disclosure.

FIG. 6A illustrates a conceptual diagram of an infrastructure-to-vehicle communication process, according to an embodiment of this disclosure.

FIG. 6B illustrates a conceptual diagram of a vehicle-to-infrastructure communication process, according to an embodiment of this disclosure.

FIG. 7 illustrates a conceptual diagram of a vehicle-to-vehicle communication process, according to an embodiment of this disclosure.

FIG. 8 illustrates a conceptual diagram demonstrating the use of a vehicle-to-vehicle communication system to perform Over-The-Air (OTA) software updates, according to an embodiment of this disclosure.

FIG. 9 illustrates a conceptual diagram demonstrating a precision localization system configured for electric/hybrid car charging, according to an embodiment of this disclosure.

FIG. 10 illustrates a flow diagram of an example process for wireless vehicle communication, according to an embodiment of this disclosure.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

Conventional RADAR systems utilize a transceiver to transmit a Radio Frequency (RF) signal (e.g., a Frequency Modulated Continuous Wave (FMCW) RF signal, pulsed RF signal, etc.) toward a target. The RF signal hits the target and returns to the RADAR unit as an echo. The return signal (e.g., echo) is then amplified and mixed with the locally generated RF signal and is further filtered via a Low Pass Filter (LPF). In such an instance, the FMCW RADAR LPF output produces a sinusoid at a frequency that depends on the roundtrip travel time. The one-way travel time is calculated from this frequency and converted to distance using the propagation speed of the RF signal in the medium (usually speed of light). The RF wave that hits the target is spread over space and hits various parts of the target surface area, and thus, the return signal may contain many echoes. Accordingly, instead of a single frequency, a continuum of frequencies is generated at the LPF output of the RADAR (i.e., clutter). The clutter does not allow the RADAR to generate precise range information for a nearby object.

Cooperative Driving Automation (CDA) is growing rapidly and is becoming more widely adopted. Meeting the extensive communication requirements, ensuring reliability, cybersecurity, and safety for such systems pose significant challenges. One major hurdle is the establishment of robust communication protocols to ensure seamless, low latency, and secure data exchange between vehicles and various elements of the transportation infrastructure.

Achieving interoperability among diverse vehicle types, brands, and communication standards is another significant challenge. Furthermore, ensuring the reliability and low-latency communication necessary for safety-critical applications demands sophisticated technologies.

Cybersecurity is a pervasive concern, as the increasing connectivity in these systems makes them susceptible to cyber threats. Therefore, leveraging the existing array of sensors and processors found in modern vehicles could be highly beneficial in addressing these challenges.

A typical modern vehicle contains over 100 Micro Controller Units (MCUs) and 60-100 sensors of various types, including 6 to 10 RADAR sensors. This disclosure is directed to a technology to use the RADAR systems already in place on vehicles (and/or other devices) to establish secure, reliable, and low-cost communications between vehicles (or more generally objects) and between vehicles (or objects) and infrastructure.

A communication system may include a RADAR transceiver configured to be implemented in a first apparatus and a transponder configured to be implemented in a second apparatus. The first apparatus and the second apparatus may be configured to communicate via a method of communication. For example, the method may include: sending, via the RADAR transceiver, an RF signal for detection of the transponder; receiving, via the transponder, the RF signal; generating, via the transponder, a response (e.g., echo) to the signal, the response including embedded information (i.e., the echo containing embedded information); sending, via the transponder, the response (e.g., modified echo, modified return signal, etc.) to the RADAR transceiver; receiving, via the RADAR transceiver, the response and extracting the embedded information; and executing, one or more actions based at least in part on the embedded information.

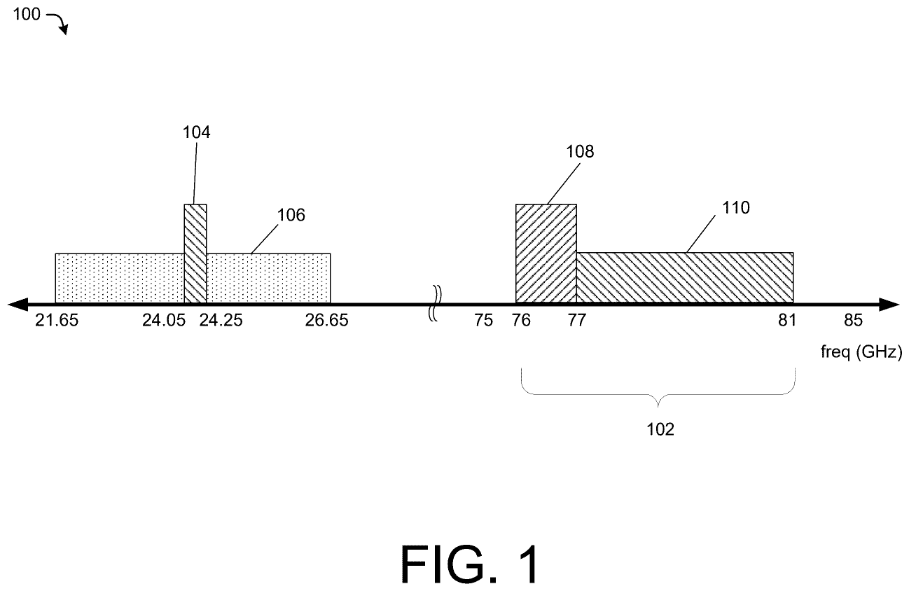

Specifically, FIG. 1 illustrates some of the frequency bands 100 of modern automotive Radio Detection And Ranging (RADAR). Although the frequency range spanning from approximately 76 GHz to 81 GHz has gained acceptance in the majority of countries and is the preferred frequency band for automotive RADAR systems 102 (“preferred automotive RADAR frequency band”), embodiments of this disclosure may operate in any frequency band. The frequency range for Instrumental Scientific Medical (ISM) bands 104 is from approximately 24 GHz to 24.5 GHz with a bandwidth of 250 MHz. The frequency range for the Ultra Wide Band (UWB) 106 is approximately 21 GHz to approximately 26 GHz. The frequency range for automotive Long-Range RADAR (LRR) 108 is from 76 GHz to 77 GHz with a bandwidth of 1 GHz. The frequency range for automotive Short-Range RADAR (SRR) 110 is from 77 GHz to 81 GHz with a bandwidth of 4 GHz.

The main advantage of the SRR 110 (“77 GHz band 110”) is a higher available bandwidth (BW) leading to better resolution, a smaller unit footprint, and higher permitted radiated power levels. The Effective Isotropic Radiated Power (EIRP) for automotive RADAR in the 77 GHz band 110 is 55 dBm (-3 dBm/MHz), while for 24 GHz RADARs the peak limit is only 20 dBm EIRP.

The automotive RADAR functions as a comprehensive transceiver system, encompassing all the components typically found in a communication transceiver. However, in automotive applications, it is originally designed for an entirely different purpose. In the conventional Frequency Modulated Continuous Wave (FMCW) RADAR, which is extensively used in the automotive industry, a RADAR transmitter (TX) emits a burst of RF signal with a chirped frequency pattern. Upon encountering an obstacle, the RADAR receives an echo with a temporal delay. The RADAR's receiver (RX) then mixes this echo with a duplicate of the originally transmitted signal. The delay between the two signals manifests itself as a sinusoidal signal whose frequency carries distance information.

The objective is to harness the extensive capabilities of these pre-existing RADAR transceivers to establish economical, reliable, and secure communication channels between vehicles. A potential advantage to the national transportation system includes enhancing overall efficiency and safety. By maximizing the utility of these already present transceivers, the transportation network (e.g., the CDA network, etc.), may be improved to be more robust and trustworthy.

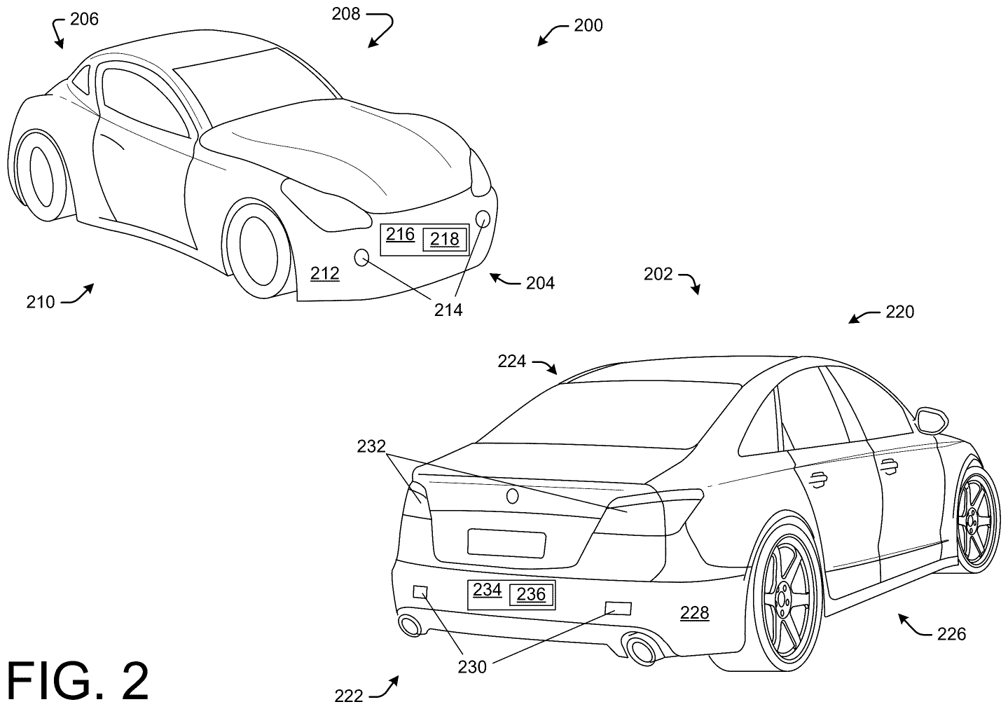

FIG. 2 illustrates a front, side view of a first vehicle 200, and a rear, side view of a second vehicle 202. In an embodiment, the vehicle 200 may include a front end 204, a rear end 206, a first side 208 (e.g., driver's side, left side), and a second side 210 (e.g., passenger side, right side). The front end 204 of the first vehicle 200 may include a bumper 212 (e.g., front bumper, first bumper, etc.). In an embodiment, the front bumper may include one or more front-facing RADAR transceivers 214 (“front transceivers”). In an embodiment, the front transceivers 214 may be installed on the bumper 212. In an embodiment, the front transceivers 214 may be integral with the bumper 212 (i.e., the front transceivers 214 may be built into the bumper 212 at the time of manufacture and/or initial assembly of the vehicle 200. Alternatively, in an embodiment, the front transceivers 214 may be added to a vehicle after initial manufacture. It is conceivable that there are other front-facing portions of a vehicle on which the front transceivers 214 may be installed besides the bumper 212.

The front transceivers 214 may be electrically connected to a RADAR unit 216. The RADAR unit 216 may be configured to receive and process any signal that has been modulated (e.g., amplitude modulated, phase modulated, frequency modulated, and/or any combination thereof, etc.). The RADAR unit 216 may include a microcontroller unit (MCU) 218. The MCU 218 may be configured to process signals received by the RADAR unit 216.

In an embodiment, the vehicle 202 may include a front end 220, a rear end 222, a first side 224 (e.g., driver's side, left side), and a second side 226 (e.g., passenger side, right side). The rear end 222 of the vehicle 202 may include a bumper 228 (e.g., rear bumper, tail bumper, etc.). In an embodiment, the bumper 228 may include one or more rear-facing RADAR transponders 230 (“rear transponders”). In an embodiment, the rear transponders 230 may be installed on the bumper 228 and/or near a light assembly 232 (e.g., tail-light assembly, reverse lights assembly, brake light assembly, etc.). In an embodiment, the rear transponders 230 may be integral with the bumper 228 (i.e., the rear transponders 230 may be built into the bumper 228 at the time of manufacture and/or initial assembly of the vehicle 202. In an embodiment, the rear transponders 230 may be placed on the rear end 222 of vehicle 202, possibly within or in proximity of the tail-light assembly 232 where power is accessible. Alternatively, in an embodiment, the rear transponders 230 may be added to a vehicle after initial manufacture. It is conceivable that there are other rear-facing portions of a vehicle on which the rear transponders 214 may be installed besides the bumper 228.

The rear transponders 230 may be electrically connected to a RADAR unit 234. The RADAR unit 234 may be configured to receive and process any signal that has been modulated (e.g., amplitude modulated, phase modulated, frequency modulated, and/or any combination thereof). The RADAR unit 234 may include a microcontroller unit (MCU) 236. The MCU 236 may be configured to process signals received by the RADAR unit 234.

Although FIG. 2 depicts vehicle 200 as having the front transceivers 214 installed thereon and vehicle 202 as having the rear transponders 230 installed thereon, it is understood that a single vehicle (e.g., vehicle 200, vehicle 202, or any other vehicle) may have transceivers on both the front of the vehicle (e.g., front transceiver 214) and on the back of the vehicle (not shown), and transponders on both the front of the vehicle (not shown) and on the back of the vehicle (e.g., rear transponders 230). It is also understood that a single vehicle may have any number of transceivers and/or transponders installed in various locations on the vehicle (i.e., a single vehicle may have one or more front transponders and/or transceivers, one or more rear transponders and/or transceivers, one or more driver's side transponders and/or transceivers, one or more passenger side transponders and/or transceivers, etc.) to allow for communication between vehicles and/or compatible receiving/transmitting devices that are in front of, behind, or laterally adjacent to a vehicle.

Conventional transponders found in traditional satellite telecommunications may receive, amplify, perform frequency shift, and reflect a signal back to a transceiver (e.g., transmitter, etc.). In an embodiment, the disclosed transponders may act as reflective mirrors in the sky and function as fully operational transceivers in terms of the radio frequency (RF) system front-end. In an embodiment, the disclosed transponders, unlike traditional regenerative repeaters, may not engage in down-conversion and baseband (BB) signal processing to regenerate and return the signal. Rather, the disclosed transponders may not only bounce back the signal to the source RADAR transmitter, thus significantly enhancing target recognition, but they also impart additional information through various modulation methods. The information to be exchanged can be modulated as a signal that is amplitude modulated (AM), phase modulated, frequency modulated (FM), or a combination thereof and returned by the transponder to a RADAR unit.

In an embodiment, a transponder that is able to impart additional information may be a cost-effective way for integrating and utilizing an additional communication system in a vehicle (e.g., automobile, semi-truck, etc.) for automotive applications.

In an embodiment, the RADAR unit 216 on vehicle 200 may emit a frequency-chirped burst in LRR configuration (“RADAR burst”) via the front transceivers 214. If the vehicle 202 is located in front of the vehicle 200, the rear transponders 230 on the bumper 228, may capture the RADAR burst. Instead of reflecting the RADAR burst, the rear transponders 230 may modulate (e.g., amplitude modulate, etc.) the RADAR burst to generate a modulated echo (e.g., modulated return signal, return signal, etc.). The rear transponders 230 may utilize modulation to embed data that vehicle 202 intends to send to the vehicle 200 before sending the return signal back to the vehicle 200. The vehicle 202 may then emit the modulated return signal back to the RADAR unit 216 on vehicle 200.

In an embodiment, the RADAR unit 216 in vehicle 200 may receive the modulated return signal from the rear transponders 230 of the vehicle 202. The MCU 218 may process the modulated return signal to extract the modulated embedded data as well as the location data from the echo. In an embodiment, this communication process between vehicle 200 and vehicle 202 may be performed without modifying the existing RADAR unit 216 in vehicle 200 or the RADAR unit 234 in vehicle 202. Instead, the MCU 218 in vehicle 200 and the MCU 236 in vehicle 202 for each RADAR unit 216/230 may be reprogrammed.

In an embodiment, each MCU 218/236 of the RADAR unit 216/234, respectively, may be reprogrammed to extract the embedded data in the modulated return signal transmitted. For example, if the RADAR unit 216 of vehicle 200 sends a signal via the front transceivers 214 of vehicle 200 to the rear transponders 230 of vehicle 202, the vehicle 202 may send a modulated return signal with additional information embedded back to the vehicle 200. In this example, the MCU 218 of the RADAR unit 216 may be reprogrammed to extract the additional information embedded in the modulated return signal sent by the vehicle 202.

In an embodiment, extracting the additional information may be simplified by the signal being modulated in the amplitude of the return signal at a known carrier frequency. In an embodiment, simple envelope detection may allow a first vehicle (e.g. signal-sending vehicle, vehicle 200, etc.) to extract the additional data sent by the second vehicle (e.g., return-signal-sending vehicle, vehicle 202, etc.).

In an embodiment, as the vehicle 200 emits a frequency burst signal to vehicle 202, a built-in data framing mechanism occurs organically that may follow a sawtooth or triangular chirp profile, that may delineate burst boundaries. Vehicle 202 may leverage this characteristic to synchronize its data transmission in relation to the received bursts. Importantly, this does not impact the fundamental operation of the RADAR, as the baseband return signal and the AM signal's sidelobe frequency continues to convey target distance information. The incorporation of data transmission (i.e., the inclusion of modulated data embedded in the return signal) alongside the existing functionality, enhances the pre-existing RADAR system's capabilities, thus reducing the end price for incorporating the additional communication system in vehicles. When the RADAR of vehicle 200 sends out a frequency modulated continuous wave (FMCW) signal that hits a target, the echo that is returned generates a signal with a frequency indicating information about the distance between the vehicle 200 to the target.

The systems and methods of this disclosure do not only facilitate communication between vehicles and transportation infrastructures through a broadly allocated frequency band originally designated for a different purpose. Rather, they also enable the acquisition of precise range information and pose information (i.e., the position and orientation of an object) from various transponder units. For example, the typical return signal (i.e., echo, etc.) may be modulated and include additional embedded information that may be extracted and processed by the vehicle receiving the return signal.

The additional information being incorporated into return signals may be crucial in determining the relative positioning and pose of other vehicles, traffic patterns, road hazards, visibility hazards, or any other condition that may impact travel conditions for a vehicle.

The transponders disclosed (e.g., rear transponders 230, front transponders, etc.) herein and the systems and methods described herein that utilize these transponders may share similarities with interplanetary localization and navigation systems and devices that utilize pulsars (i.e., celestial bodies emitting rhythmic pulses of radiation, that exhibit highly precise and stable brightness modulation frequencies, comparable to unique signatures for each pulsar). However, unlike pulsars with fixed pulsation frequencies, the pulsations of the disclosed transponders (e.g., front transponder 214 and rear transponders 230) convey data while retaining a known average pulsating frequency.

In an embodiment, the transponders (e.g., rear transponders 230, not shown front transponders, etc.) may produce a modulated return signal that, upon processing by the corresponding MCU 218/236 of the RADAR appropriate unit 216/234, may generate an AM narrowband signal at the modulating frequency. The envelope signal, containing subcarriers around the oscillating center frequency, may carry both data and information about the target distance relative to the transponder that sent the signal. In an embodiment, the transponders (e.g., rear transponders 230) may be used as radio beacons with known locations on the target vehicle, envisioning standardization in this regard.

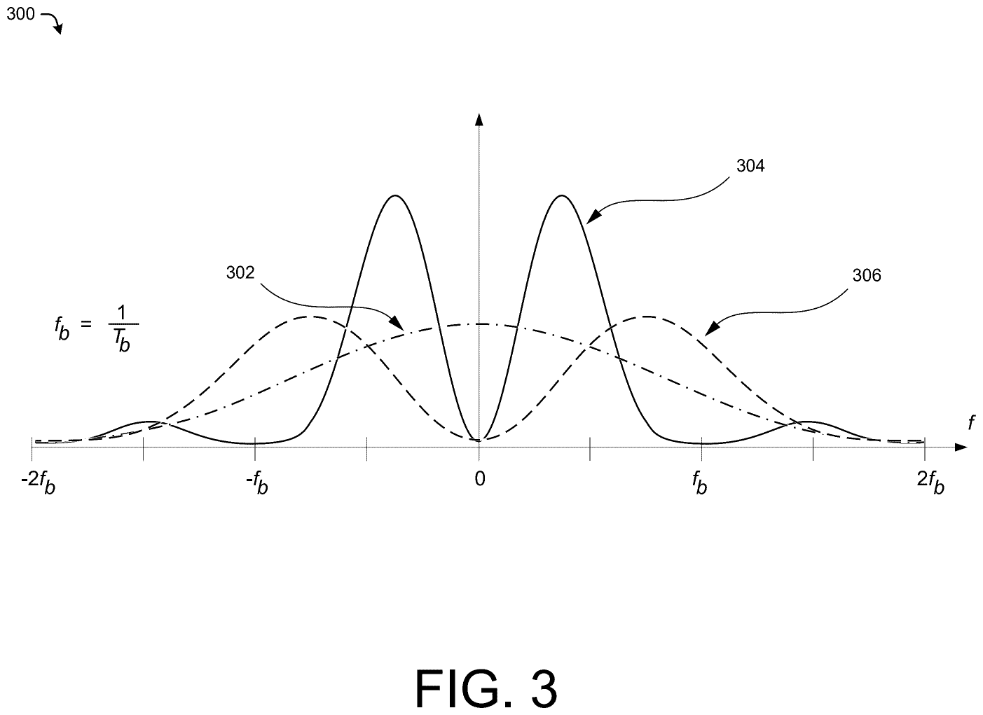

FIG. 3 illustrates a chart 300 illustrating the power spectrum for three examples of line codes (e.g., polar, bipolar Alternate Mark Inversion, and split phase or Manchester encoding), pursuant to the relationship ƒ_{b}=1/T_{b}, wherein ƒ_{b} is the bit rate and T_{b} is the bit period. The chart 300 includes a graphical representation of a Polar (“Polar”) 302, a Bipolar Alternate Mark Inversion (“Bipolar AMI”) 304, and a Split-Phase or Manchester 306.

In an embodiment, target distance may be obtained either from analysis of baseband (BB) return signal or through transmitted carrier AM. In such cases, there will be a signal component carrying target distance information which may be obtained through simple Fourier analysis.

In an embodiment, the Bipolar AMI 304 has spectral null at data transmission rate ƒ_{b}. In an embodiment, a pilot may be included at this frequency that leads to a Delta function in the frequency domain. It may be shown that the transponder return signal, when mixed by the RADAR generated frequency chirp, may create a sidelobe whose frequency may be offset relative to ƒ_{b}. The transponder return signal may also provide information about transponder distance to the RADAR system. In an embodiment, most of the clutter appears near the direct current (DC) and may thus be filtered out.

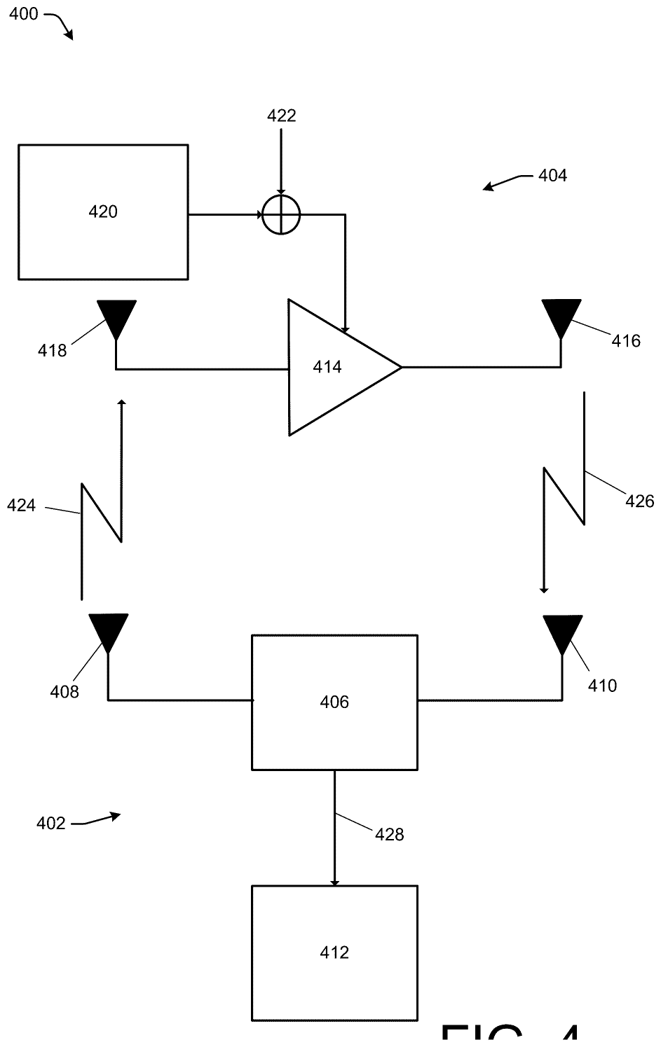

FIG. 4 illustrates a block diagram 400 for signal processing. In an embodiment, the block diagram 400 may include a RADAR transceiver 402 (e.g., composed of first vehicle RADAR plus other hardware, etc.) and a transponder 404 (e.g., second vehicle transponder, etc.). In an embodiment, the transponder 404 may be an active low noise amplifier transponder.

In an embodiment, the RADAR transceiver 402 may include a RADAR board 406, a first transmitter antenna 408 (e.g., RADAR transmitter), and a first receiver antenna 410 (e.g., RADAR antenna). In an embodiment, the RADAR board 406 may be configured to perform baseband processing 412.

In an embodiment, the transponder 404 may include a low noise amplifier (LNA) 414, a second transmitter antenna 416 (e.g., transponder transmitter), a second receiver antenna 418 (e.g., transponder antenna), and an arbitrary waveform generator 420. The second transponder 404 may be configured to receive a DC offset signal 422.

In an embodiment, the RADAR board 406 may transmit a FMCW waveform 424 via the first transmitter antenna 408 to the second transponder 404 (i.e., a first vehicle may transmit a signal towards a second vehicle adjacent to the first vehicle). In an embodiment, the second transponder 404 may receive the FMCW waveform 424 via the second receiver antenna 418. In an embodiment, AM may be used to convey data to the first transceiver 402 via the second transponder 404.

In an embodiment, the power supplied to the LNA 414 may be modulated. In an embodiment, the data may integrate with a pilot specifically designated to identify the first transponder 404 and estimate the distance between the first RADAR transceiver 402 and the second transponder 404. The DC offset signal 422 may be present to indicate that the LNA 414 is continuously powered while its gain is modulated. In an embodiment, the LNA 414 may produce a modulated return signal. In an embodiment, Variable Gain Amplifier (VGA) may be used (VGA not shown) to modulate a return signal. In an embodiment RF mixer (not shown) may be used after the LNA which is supplied a fixed voltage (i.e., not power modulated) and the RF mixer may be used to modulate data on the return signal.

In an embodiment, the LNA 414 may transmit a modulated return signal 426 to the first RADAR transceiver 402 via the second transmitter antenna 416. In an embodiment, the first receiver antenna 410 may receive the modulated return signal 426. In an embodiment, the RADAR board 406 may receive the modulated return signal 426 from the first receiver antenna 410 and mix it with a replica of the FMCW waveform 424 that was transmitted to the second transponder 404. In an embodiment, the RADAR board 406 may perform low pass filtering and present a processing signal 428 for baseband processing 412.

In an embodiment, the processing signal 428 may be further processed. In an embodiment, one or more antenna polarization strategies may be employed to remedy a potential self-interference problem associated with use of a single LNA as a transponder without frequency shifting. For example, the signal arriving at the input of the transponder may be relatively weak while the signal at LNA output may have a much higher power level. Accordingly, there may be a high potential for positive feedback from transponder output back to its input.

In an embodiment, using polarized antennas at the RADAR transceiver 402 (e.g., the first transmitter antenna 408 and the first receiver antenna 410) and the transponder 404 (e.g., the second transmitter antenna 416 and the second receiver antenna 418) to reduce self-interference. For example, the first transmitter antenna 408 of the first RADAR transceiver 402 and the second receiver antenna 418 of the second transponder 404 may be vertically polarized, while the first receiver antenna 410 of the first RADAR transceiver 402 and the second transmitter antenna 416 of the second transponder 404 may be horizontally polarized. In that case, the two antennas (i.e., the receiving antenna and the transmitting antenna) on each unit may be in orthogonal polarization states and may thus lead to self-interference cancellation.

In an embodiment, the use of In-Band Full-Duplex (IBFD) technology for self-interference cancellation assuming a hybrid architecture may be used. When using IBFD technology, the communications between a first vehicle and a second vehicle may be bi-directional, thus any possible interference between embedded signal data in two directions may be mitigated. When using IBFD technology, the proximity between a transponder of a first vehicle and a transponder unit of a second vehicle may be problematic since the transponders basically operate in the same frequency band. Since the first vehicle is fully aware of the data it is sending to the second vehicle, whenever the first vehicle receives a signal from the second vehicle, the first vehicle may cancel out the data sent to the second vehicle. After the first vehicle cancels out the data sent to the second vehicle, the resulting information is recognized as originating from the second vehicle only.

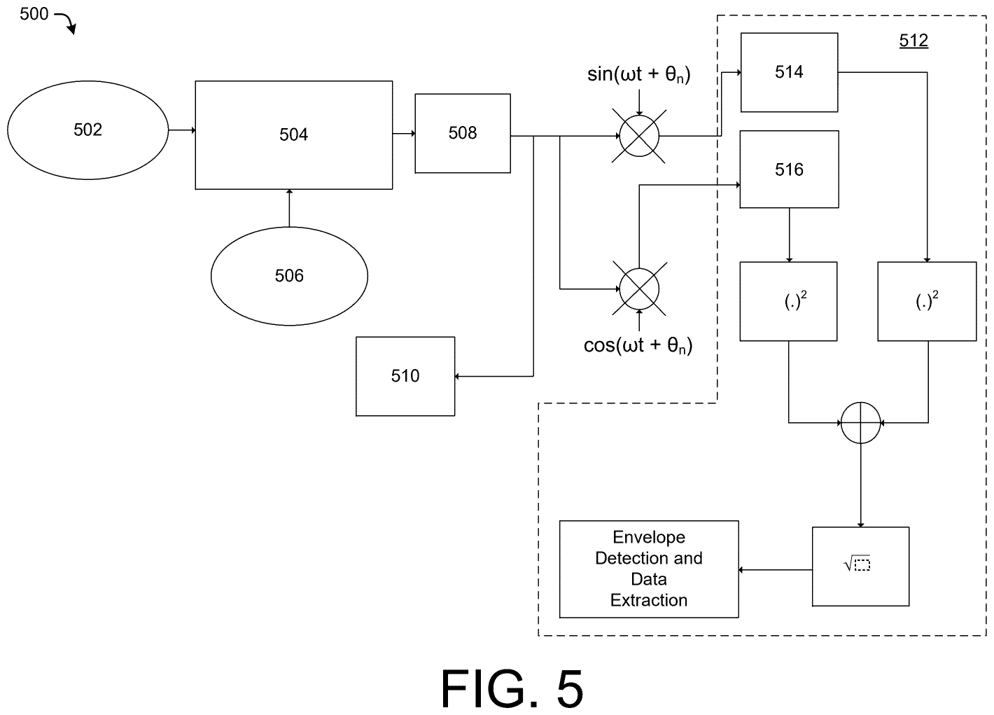

FIG. 5 illustrates a block diagram illustrating a data detection/extraction process 500 (“process 500”) that uses a Quadrature Mixing Technique. In an embodiment, the process 500 may include a baseband signal 502, an Analog-to-Digital Conversion and Data Framing process 504 (“process 504”), a chirp timing process 506, a band pass filter 508, a Fast Fourier Transform process 510 (“FFT process 510”), an Envelope Detection and Data Extraction Process 512. In an embodiment, the Envelope Detection and Data Extraction Process 512 may include a first low pass filter 514 and a second low pass filter 516.

In an embodiment, data extraction may utilize pure envelope detection using rectifiers (not shown). In an embodiment, the process 500 may receive the baseband signal 502 from a RADAR transceiver (e.g., the first RADAR transceiver 402) that employs a sawtooth or triangular frequency chirp at fixed periodic intervals, synchronizing data bursts to this cycle. In an embodiment, the chirp timing signal may frame a sequence of samples associated with the process 504. In an embodiment, the process 504 may receive the baseband signal 502 and utilize the chirp timing process 506 to further process the signal.

The band pass filter 508 may be utilized to eliminate low-frequency clutter in the signal. The band pass filter 508 may focus on data and pilot signal samples with a precise Power Spectral Density (PSD) location around the spectrum's data rate frequency. The FFT process 510 may be employed to precisely track the pilot frequency.

The offset of the pilot frequency may provide transponder distance information relative to the nominal value. In an embodiment, the first low pass filter 514 and the second low pass filter 516 may continue the Envelope Detection and Data Extraction Process 512 to extract the line-coded data conveyed by the signal envelope.

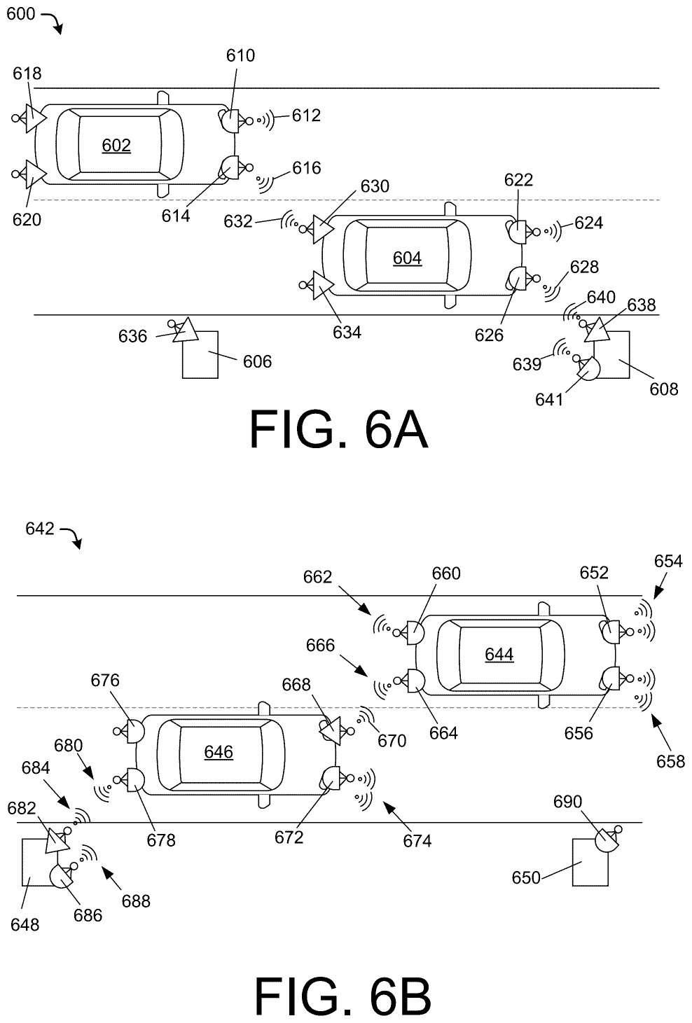

FIG. 6A illustrates a conceptual diagram of an infrastructure to vehicle communication process 600 (“process 600”). In an embodiment, the process 600 may include a first vehicle 602, a second vehicle 604, a first roadside infrastructure 606, and a second roadside infrastructure 608.

In an embodiment, the first vehicle 602 may include a first front RADAR transceiver 610 configured to generate and send a first signal 612 (e.g. first RF signal, etc.). In an embodiment, the first vehicle 602 may include a second front RADAR transceiver 614 that may be configured to generate and send a second signal 616 (e.g., second RF signal, etc.). In an embodiment, the first vehicle 602 may include a first rear transponder 618. In an embodiment, the first vehicle 602 may include a second rear transponder 620. In an embodiment, each transceiver/transponder (e.g., the first front RADAR transceiver 610, the second front RADAR transceiver 614, the first rear transponder 618, the second rear transponder 620, etc.) may be configured to send and/or receive a signal (e.g., the first signal 612, the second signal 616, etc.).

In an embodiment, the second vehicle 604 may include a first front RADAR transceiver 622 configured to generate and send a first signal 624. In an embodiment, the second vehicle 604 may include a second front RADAR transceiver 626 that may be configured to generate and send a second signal 628. In an embodiment, the second vehicle 604 may include a first rear transponder 630 that may be configured to receive the second signal 616. In an embodiment, the first rear transponder 630 may be configured to produce a return signal 632 (e.g., modulated echo, modulated signal, etc.) by processing the second signal 616 (i.e., modulating the second signal 616 to produce a modulated echo). For example, the first rear transponder 630 may receive the second signal 616 and generate the return signal 632 (i.e., embed additional information via modulation into a reflection of the second signal 616). The first rear transponder 630 may be configured to send the return signal 632. The second front RADAR transceiver 614 may be configured to receive the return signal 632, and the first vehicle 602 may process the return signal 632 to extract the embedded information from the return signal 632 (e.g., additional information embedded into the return signal via modulation). The first vehicle 602 may also process the return signal 632 to determine location data relative to the second vehicle 604. In an embodiment, the second vehicle 604 may include a second rear transponder 634.

In an embodiment, the first roadside infrastructure 606 (e.g., road sign post, guard rail, building, or other object adjacent to a path) may include a transponder 636. In an embodiment, the second roadside infrastructure 608 may include a transponder 638. The transponder 638 may be configured to receive the second signal 628. In an embodiment, the transponder 638 may be configured to produce a return signal 640 (modulated echo, modulated signal, etc.) by processing (e.g., modulating) the second signal 628. For example, the transponder 638 may receive the second signal 628 and generate the return signal 640 (i.e., embed additional information via modulation into a reflection of the second signal 628 (e.g., echo, etc.)). The transponder 638 may be configured to send the return signal 640. The second front RADAR transceiver 626 may be configured to receive the return signal 640, and process the return signal 640 and extract information from the return signal 640 (e.g., additional information embedded into the return signal, etc.).

While FIG. 6A illustrates the transponder 638 receiving only the second signal 628, the transponder 638 may be configured to receive one or more different signals (e.g., the first signal 612, the second signal 616, the first signal 624, etc.) from one or more RADAR transceivers (e.g., the first front RADAR transceiver 610, the second front RADAR transceiver 614, etc.).

In an example process, the second roadside infrastructure 608 may independently transmit a signal 639 that includes relevant travel information (e.g., pending road closure, approaching construction zone, or other useful information), via a transceiver 641. For example, announcements for scheduled road maintenance may be distributed to travelers before any vehicles encounter the maintenance area. In an example process, the transponder 638 may receive the second signal 628, and process (e.g., modulate) the second signal 628 to produce the return signal 640 that may contain information related to imminent road conditions, which may be sent back to the second vehicle 604. The second vehicle 604 may relay the information from the return signal 640 to the first vehicle 602 via the first rear transponder 630 and the return signal 632. The first vehicle 602 may receive the return signal 632, process the embedded information (e.g., the information originating from the second roadside infrastructure 608 and embedded in the return signal 640 via modulation) and make one or more navigational adjustments as required.

In an embodiment, signal relaying may be used to enable the process 600. In an embodiment, the process 600 may be similar to vehicle-to-vehicle communication using beamforming, but employs switched beams, and multi-beams technologies. In an embodiment, front RADAR transceivers in a vehicle may be adapted to perform beam switching, for instance over 30 degree sectors. In an embodiment, the RADAR transceiver may switch when the vehicle (e.g., the first vehicle 602) approaches a roadside object (e.g., the first roadside infrastructure 606) while maintaining one beam (e.g., the second signal 616) on an adjacent vehicle (e.g., the second vehicle 604). In an embodiment, rear transponders (e.g., the first rear transponder 630, the second rear transponder 634, etc.) in a front vehicle (e.g., the second vehicle 604) may be used to perform vehicle-to-vehicle communication with a following vehicle (e.g., the first vehicle 602). In an embodiment, the vehicle-to-vehicle communication may be possible because the look angle for one of more transponders may be low, thus, information may be relayed to adjacent vehicles.

FIG. 6B illustrates a conceptual diagram of a vehicle to infrastructure communication process 642 (“process 642”). In an embodiment, the process 642 may include a first vehicle 644, a second vehicle 646, a first roadside infrastructure 648, and a second roadside infrastructure 650.

In an embodiment, the first vehicle 644 may include a first front RADAR transceiver 652 that may be configured to send a first signal 654. In an embodiment, the first signal 654 may be sent in multiple directions. In an embodiment, the first vehicle 644 may include a second front RADAR transceiver 656 that may be configured to send a second signal 658 in one or more directions. In an embodiment, the first vehicle 644 may include a first rear transceiver 660 that may be configured to send first signal 662. In an embodiment, the first vehicle 644 may include a second rear transponder 664 that may be configured to send a second signal 666. In an embodiment, the first signal 662 and the first signal 666 may both include additional information related to imminent travel conditions (e.g., a stalled vehicle ahead, a clear roadway, or other useful information, etc.).

In an embodiment, the second vehicle 646 may include a first front RADAR transponder 668. The first front RADAR transponder 668 may be configured to receive the signal 666. In an embodiment, the first front RADAR transceiver 668 may be configured to process the signal 666 and generate a return signal 670. In an embodiment, the first front RADAR transponder 668 may be configured to send the return signal 670 back to the first vehicle 644. In an embodiment, the second vehicle 646 may include a front RADAR transceiver 672 that may be configured to send a signal 674. The signal 674 may include the information the second vehicle 646 received from the second signal 666. The signal 674 may be sent in multiple directions toward objects that may be configured to receive and process the information (e.g., additional adjacent vehicles, road infrastructure, etc.).

In an embodiment, the second vehicle 646 may include a first rear transceiver 676 and a second rear transceiver 678. The second rear transceiver 678 may be configured to generate a signal 680. The signal 680 may include the information the second vehicle 646 received from the second signal 666. The second rear transponder 678 may be configured to send the signal 680.

In an embodiment, the first roadside infrastructure 648 may include a RADAR transponder 682. In an embodiment, the RADAR transponder 682 may be configured to receive the signal 680. In an embodiment, the RADAR transceiver 682 may be configured to generate a return signal 684. In an embodiment, the RADAR transponder 682 may be configured to send the return signal 684 back to the to a transceiver (not shown) of the second vehicle 646. In an embodiment, the first roadside infrastructure 648 may include a transceiver 686 configured to generate and transmit a signal 688. In an embodiment, the transceiver 686 may be sent with similar or different information that the return signal 684. In an embodiment, the second roadside infrastructure 650 may include a RADAR transceiver 690.

In an example process, the second vehicle 644 may transmit information (e.g., a stalled vehicle ahead, a clear roadway, or other useful information, etc.), via the second signal 666, to the second vehicle 646. The second vehicle 646 may relay the information to the first roadside infrastructure 648. In an embodiment, the first roadside infrastructure 648 may relay the information to additional passing vehicles. The first roadside infrastructure 648 may also receive additional information in a similar manner that indicates when the information is no longer relevant (i.e., the hazard is clear, there is no longer a traffic delay, etc.).

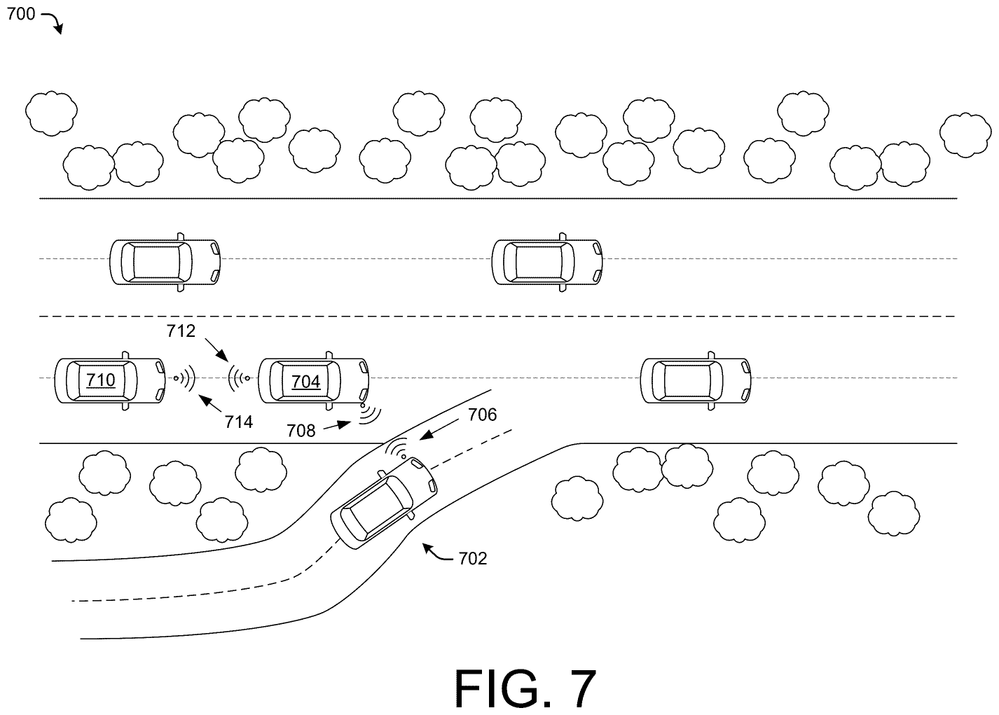

FIG. 7 illustrates a conceptual diagram of a vehicle-to-vehicle communication process 700 (“process 700”). In an embodiment, the process 700 may include a first vehicle 702 and a second vehicle 704. The first vehicle 702 may be configured to send a signal 706. In an embodiment, the second vehicle 704 may be configured to receive the signal 706, process the signal 706, generate a return signal 708 (e.g., echo, modulated signal, modulated echo, etc.), and transmit the return signal 708. In an embodiment, the first vehicle 702 may be configured to receive and/or process the return signal 708. For example, the first vehicle 702 may be configured to receive the return signal 708 from the second vehicle 704 and extract information embedded into the return signal 708 by the second vehicle 704.

In an embodiment, the process 700 may include a third vehicle 710. In an embodiment, the second vehicle may receive the signal 706 from the first vehicle 702, process the signal 706, generate a signal 712, and transmit the signal 712 to the third vehicle 710. In an embodiment, the third vehicle 710 may generate a return signal 714 (e.g., echo, modulated echo, modulated return signal, etc.) and transmit the signal 714 to the second vehicle 704. The second vehicle 704 may receive the return signal 714 from the third vehicle 710, process the return signal 714, and generate the signal 708. The signal 708 may include information that the second vehicle 704 received from the return signal 714 (e.g., the third vehicle 710 is slowing down, etc.). The second vehicle 704 may transmit the signal 708 to the first vehicle 702. The first vehicle 702 may receive the signal 708 and take an appropriate action (e.g., merge into the lane at a particular speed because the traffic has slowed, refrain from merging because the traffic has not slowed, etc.).

Short-range Vehicle to Vehicle (V2V) communication systems may offer diverse potential applications including preventing collisions, assisting in lane changes, facilitating automated parking, and Cooperative Adaptive Cruise Control (CACC). V2V communication systems may benefit from establishing a prompt communication link with minimal latency among nearby vehicles.

In an embodiment, a low-latency communication link may be highly advantageous in safety-critical applications, particularly where traditional Vehicle-to-Cloud (V2C) systems face challenges due to extended processing times and communication delays between vehicles and the cloud, and internal to cloud networks.

The process 700 may establish a secure, cost-effective, and efficient communication link among adjacent vehicles. For example, the process 700 may be used to implement a Cooperative Collision Warning System (CCWS). A typical Collision Warning Systems (CWS) relies on on-board sensors. However, utilizing V2V communication via the process 700, the typically installed on-board sensors may be supplemented by transponders (e.g., the first rear transponder 618, the second rear transponder 620, etc.). In an embodiment, the data provided to a typical CWS may be supplemented by the data provided by the transponders (e.g., the first rear transponder 618, the second rear transponder 620, etc.).

CCWS is the result of the supplemented and enhanced CWS. CCWS facilitates the exchange of information among vehicles through process 700 (i.e., V2V communication), which may effectively identify accidents and potential hazards. In an embodiment, direct communication between vehicles utilizing the process 700, may be better suited for advanced Collision Warning Systems compared to reliance on vehicle-to-infrastructure communication systems (e.g., the process 600, the process 642, etc.).

In an embodiment, the process 700 may expand the perception range in automated driving and improve vehicle sensing for a more comprehensive representation of the vehicle's surroundings. In an embodiment, the process 700 may enable maneuver negotiation through bidirectional signal exchange, which may allow planning algorithms to rely on direct information from nearby vehicles rather than predicting their behavior. Increased use of planning algorithms relying on direct real-time information from vehicles may extend the planning horizon and enhance the overall effectiveness of planning algorithms.

The process 700 may be used to facilitate cooperative maneuvering for vehicles (e.g., lane changes, lane merging, adaptive cruise control, traffic adjustments, etc.). For example, lane merging is a common maneuver on highways and also occurs at construction sites on the road. Through the exchange of intentions using the process 700, vehicles can assist each other in coordinating their merging maneuvers, ensuring a safe and efficient process.

For example, in an embodiment, the first vehicle 702 may intend to merge onto a busy roadway. The first vehicle 702 may generate the signal 706 that may include additional embedded information about the first vehicle 702 (e.g., vehicle position, vehicle speed, vehicle dimensions, etc.). The first vehicle 702 may send the signal 706 to a second vehicle 704. The second vehicle 704 may receive the signal 706 and extract the additional embedded information. The second vehicle 704 may process the additional embedded information and slow down to a certain speed to create a gap in the traffic to accommodate the first vehicle 702. The second vehicle 704 may then generate and transmit the signal 708 to the first vehicle 702 embedded with additional information relevant to the first vehicle 702 (e.g. the second vehicle 704 has slowed down, there is a gap in traffic, etc.). The first vehicle may receive the signal 708, process the signal 708, and merge into the gap created by the second vehicle 704.

In an embodiment, the second vehicle 704 may produce and transmit the signal 712 to the third vehicle 710. In an embodiment, the signal 712 may provide additional information to the third vehicle 710 to indicate that the first vehicle 702 is merging into the line of traffic and that the second vehicle 704 is slowing down. The third vehicle 710 may receive the signal 712 and slow down to accommodate.

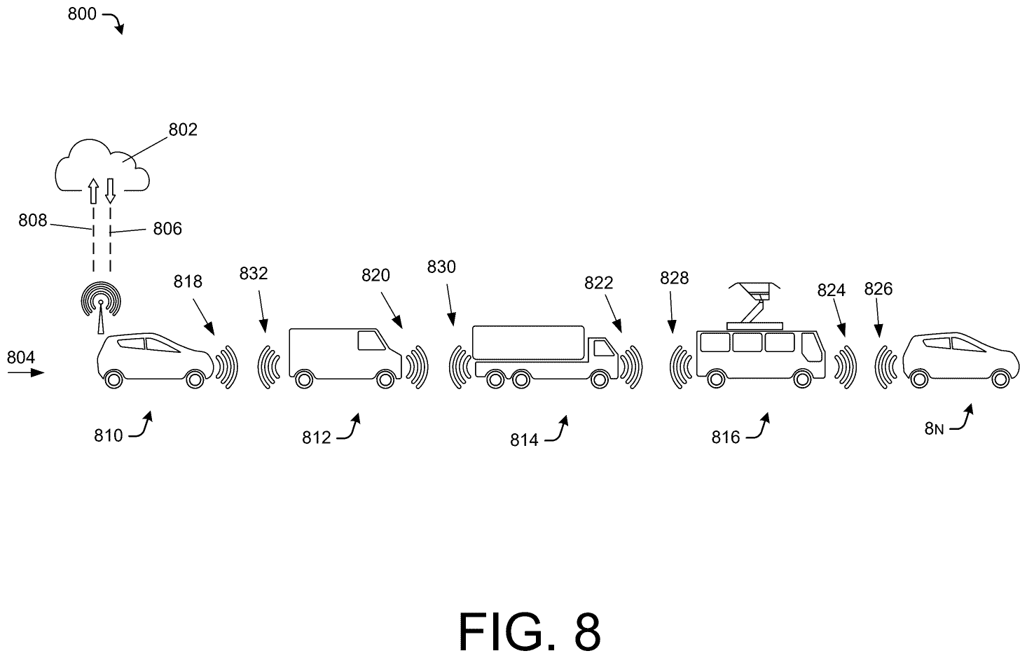

FIG. 8 illustrates a conceptual diagram demonstrating the use of a vehicle-to-vehicle communication system 800 (“system 800”) to perform over-the-air (OTA) software updates. In an embodiment, the system 800 may include a cloud network 802 and a fleet of vehicles 804 (“fleet 804”). In an embodiment, the cloud network 802 may be configured to send a signal 806. In an embodiment, the cloud network 802 may be configured to receive a signal 808. In an embodiment, the fleet 804 may include multiple vehicles (e.g., a first vehicle 810, a second vehicle 812, a third vehicle 814, a fourth vehicle 816, and/or any number of vehicles represented by vehicle 8n).

In an embodiment, each individual vehicle of the fleet 804 (e.g., the first vehicle 810, the second vehicle 812, the third vehicle 814, the fourth vehicle 816, and/or any number of vehicles represented by vehicle 8n) may include one or more RADAR transceiver and transponder units (“TR+TSP”) (i.e., a device that includes both a transceiver configured to generate and transmit a signal and a transponder configured to receive a signal and modulate the signal to embed additional information before sending the modulated return signal).

Apart from the advantage of low latency that the system 800 may provide, the system 800 may also furnish a cost-free data communication link, unlike a V2C system. V2C systems rely on the internet and mobile networks like 5G for data exchange and storage in the cloud. Because V2C systems rely on cellular data usage, V2C may result in significant expenses, particularly when handling substantial data transfers. Conversely, the cost-free data link that may be offered by the system 800, including the use of the additional RADAR transceivers (e.g., the first front RADAR transceiver 610, the second front RADAR transceiver 614, the first rear transponder 618, the second rear transponder 620, etc.), may enable the transfer of large amounts of data between nearby vehicles. This advantage creates opportunities for additional applications in high-rate V2V data exchange, such as Over-the-Air (OTA) Software Update for a fleet of vehicles (e.g., government vehicles, rental vehicles, freight vehicles, etc.).

OTA software updates for vehicle fleets may streamline the process of remotely updating software and firmware through wireless means, offering fleet managers a convenient, efficient, and cost-effective solution to enhance vehicle performance. This method allows simultaneous updates for multiple vehicles, saving time and resources, and facilitates timely fixes, security enhancements, and feature introductions. The scalability of OTA updates accommodates fleets of any size, and the environmental advantages arise from the reduced need for physical travel during manual updates. Successful implementation requires vehicles to be equipped with advanced telematics systems and secure communication protocols, ensuring a dependable and secure update process for the entire fleet. Despite the numerous advantages, the downside of OTA updates lies in the expense associated with having a secure and reliable telematics unit as well as a communication link connecting the vehicle to the cloud.

The expense associated with maintaining a reliable and efficient communication channel for transmitting software updates remotely may pose a financial challenge, particularly as the size of the fleet expands. Factors contributing to this cost may include data transmission charges, network infrastructure investments, and ensuring the security and stability of the communication link. However, the use of the system 800 may allow for the transfer of substantial data between vehicles with optimal security measures and minimal expenses.

For example, in an embodiment, the cloud network 802 may transmit an initial software update, via signal 806 to the first vehicle 810. In an embodiment, the first vehicle 810 may receive the signal 806, process the software update, and transmit the software update to the second vehicle 812 via a signal 818. In an embodiment, the second vehicle 812 may receive the signal 818, process the software update, and transmit the software update to the third vehicle 814 via a signal 820. In an embodiment, the third vehicle 814 may receive the signal 820, process the software update, and transmit the software update to the fourth vehicle 816 via a signal 822. In an embodiment, the fourth vehicle 816 may receive the signal 822, process the software update, and transmit the software update to the nth vehicle 8n via a signal 824.

In an embodiment, the nth vehicle 8n may generate a response signal 826 indicating whether the update was installed (e.g., installation status) in the nth vehicle 8n and transmit the response signal 826 to the fourth vehicle 816. In an embodiment, the fourth vehicle 816 may generate a response signal 828 indicating whether the update was installed (e.g., installation status) in the fourth vehicle 816 and transmit the response signal 826 to the third vehicle 814. In an embodiment, the third vehicle 814 may generate a response signal 830 indicating whether the update was installed (e.g., installation status) in the third vehicle 814 and transmit the response signal 830 to the second vehicle 812. In an embodiment, the second vehicle 812 may generate a response signal 832 indicating whether the update was installed (e.g., installation status) in the second vehicle 812 and transmit the response signal 832 to the first vehicle 810. In an embodiment, the first vehicle 810 may transmit the response signal 808 to the cloud network 802 to provide relevant information (e.g., which vehicles successfully installed the update, which vehicles still need to be updated, etc.). Although depicted and described in a particular order, the order of operations may vary (e.g., the return signal 832 may be generated by the second vehicle 812 and transmitted to the first vehicle 810 before the signal 820 is generated and transmitted by the second vehicle 812).

The implementation of secure and cost-effective V2V communication (e.g., the process 700, the system 800, etc.) in vehicles may introduce several benefits including improved traffic flow and reduced congestion through enhanced coordination between vehicles. This technology may also enable efficient route planning and optimization, leading to fuel savings and reduced environmental impact.

The use of V2V communication (e.g., the process 700, the system 800, etc.) in passenger and commercial vehicles may introduce a variety of regulatory and compliance considerations since adhering to the existing standards may pose a challenge for Original Equipment Manufacturers (OEMs) and their suppliers.

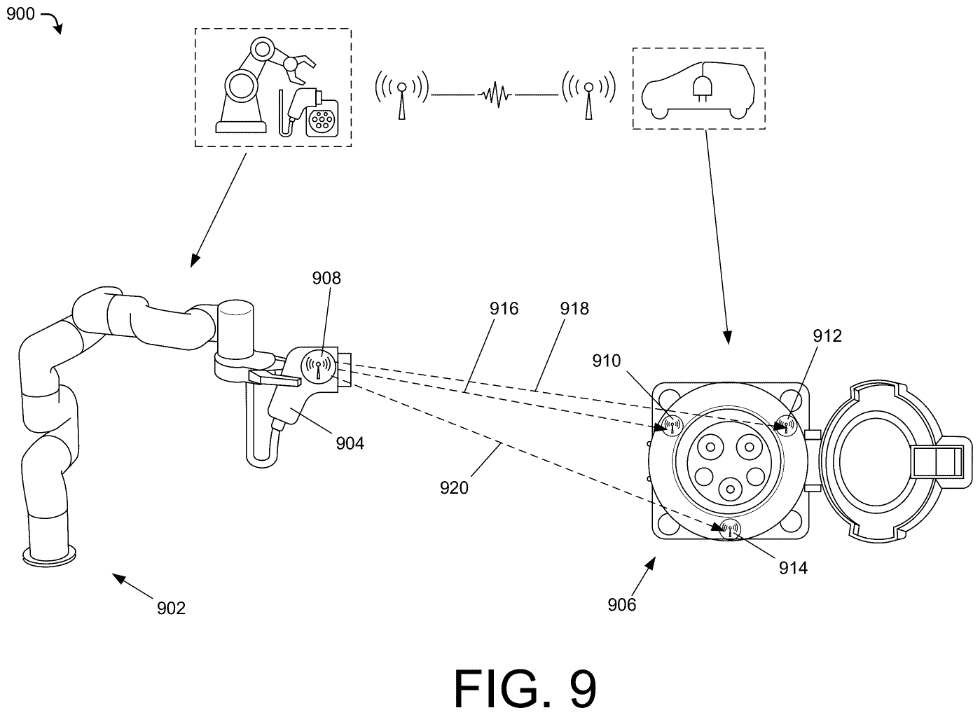

FIG. 9 illustrates a conceptual diagram demonstrating a precision localization system 900 (“system 900”) configured for electric/hybrid car charging, according to an embodiment of this disclosure. In an embodiment, the system 900 may include a robotic arm 902, a charging plug 904, and a charging port 906.

In an embodiment, the charging plug 904 may include a RADAR transceiver 908. In an embodiment, the charging port 906 may include a first transponder 910, a second transponder 912, and a third transponder 914. In an embodiment, the RADAR transceiver 908 may be similar to the RADAR transceiver 402 referenced and described above in FIG. 4. In an embodiment, the first transponder 910, the second transponder 912, and the third transponder 914 may be similar to transponder 404 referenced and described in FIG. 4 and used to intercept an RF signal and send a response (e.g., echo, modulated echo, etc.) back to the inquiring device.

In an embodiment, the first transponder 910, the second transponder 912, and the third transponder 914 may be used to provide three range measurements to precise positions relative to the RADAR transceiver 908. In an embodiment, the RADAR transceiver 908 may transmit a first signal 916 to the first transponder 910, a second signal 918 to the second transponder 912, and a third signal 920 to the third transponder 914. The first transponder 910, the second transponder 912, and the third transponder 914 may reflect the corresponding signal (916, 918, 920) to the RADAR transceiver 908 with additional information embedded (e.g., via modulation) to indicate the location of the first transponder 910, the second transponder 912, and the third transponder 914 relative to the RADAR transceiver 908. In an embodiment, the robotic arm 902 may use the location information provided by the first transponder 910, the second transponder 912, and the third transponder 914 to insert the charging plug 904 into the charging port 906.

While the system 900 is described in FIG. 9 as being applied to EV charging systems, it is understood that the system 900 may be integrated in other technologies or types of systems unrelated to vehicles and or electrical charging systems.

In an embodiment, frequency modulation (e.g., amplitude modulation, frequency modulation, etc.) of the signals (916, 918, 920) may be used to distinguish the different transponders (910, 912, 914) from each other and to distinguish the transponders (910, 912, 914) from background clutter. In an embodiment, if each transponder (e.g., the first transponder 910, the second transponder 912, and the third transponder 914, etc.) amplitude modulates the return signal at some predetermined known frequency, the demodulated signal at the output of the RADAR transceiver 908 will appear as a signal at modulation frequency of the sending transponder (e.g., the first transponder 910, the second transponder 912, and the third transponder 914), with sidelobes whose frequency separation from center carrier contain distance information to the RADAR transceiver 908. The RADAR transceiver 908 may then process each return signal (916, 918, 920) to generate range information for each transponder (916, 918, 920) at the same time. Relative localization of an object may be derived from three or more range measurements.

In an embodiment, the transponders 910, 912, 914 may be a Low Noise Amplifier (LNA) with transmitting and receiving antennas (not shown) sufficiently separated in space to avoid positive feedback (the transponder transmitting antenna signal is far stronger than its receiving antenna signal and any leakage may cause self-feedback). In an embodiment, frequency shifts the return signal and leverages filtering to minimize self-feedback, similar to the typical operations for satellite communication.

In an embodiment, the return signal 916/918/920 may be obtained by modulating the transponder 910, 912, 914 (e.g., LNA, etc.) power supply since the amplifier gain is often a function of bias currents and this current is affected by the supply voltage. Additionally, transponder self-interference may be mitigated using antenna polarization techniques. The transmitting antenna of the transponders 910, 912, 914 and the receiving antenna of the transponders 910, 912, 914 may each use an orthogonal polarization state (linear, circular or elliptical).

Alternatively, a Spatial Wave Modulator (SWM) may be utilized, since any conductive surface acts like a mirror for RF radiation. If the conductivity of the material could be modulated, the amount of reflected RF energy may also be modulated. SWM is an electrically modulated (or through some other means) surface whose conductivity is modulated via application of time varying voltage. In an embodiment utilizing SWM, the transponders (e.g., transponders 910, 912, 914) may be a small SWM surface (e.g., the size of a dime, or other reasonable size). Additionally, the signal (e.g., the first signal 916, the second signal 918, and the third signal 920, etc.) may be boosted since passive reflections from conductivity modulated surfaces tend to be very weak. Using SWM may greatly reduce power consumption because of the passive reflections, which may improve efficiency and further lower operation costs.

Other forms of intelligent surfaces may be used with SWM. For example, modulation of the reflection angle of the signal using reconfigurable meta gratings. In an embodiment, the intercepted signal would be modulated at the frequency by which the meta grating changes reflection angle.

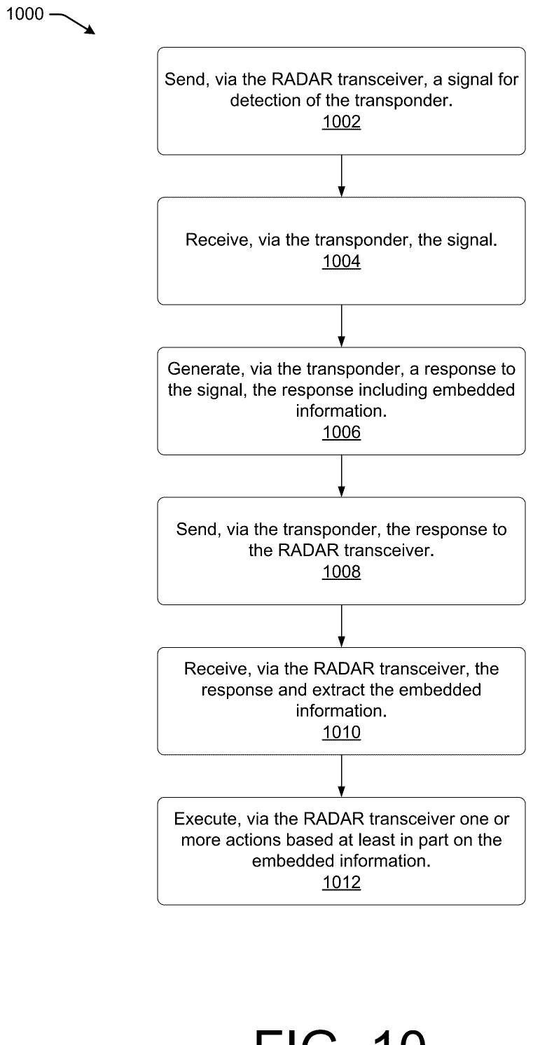

FIG. 10 illustrates a flow diagram of an example process 1000 (“process 1000”) for wireless vehicle communication. The order in which the operations or steps are described is not intended to be construed as a limitation, and any number of the described combinations may be combined in any order and/or in parallel to implement the process 1000.

In an embodiment, a method, or a communication process 1000 may include a step 1002 of sending, via the RADAR transceiver, a signal for detection of the transponder. For example, a first apparatus (e.g., first vehicle, first roadway infrastructure, etc.) may send an RF signal, via a RADAR transceiver implemented within the first apparatus, to a transponder implemented within the second apparatus (e.g., second vehicle, second roadway infrastructure, etc.) to acquire location information relative to the second apparatus. In an embodiment, a first vehicle may utilize a RADAR transceiver to send an RF signal to a transponder implemented within the second vehicle that is nearby.

In an embodiment, a method or communication process 1000 may further include a step 1004 of receiving, via the transponder, the signal. For example, the signal sent by the RADAR transceiver of the first apparatus (e.g., first vehicle, first roadway infrastructure, etc.) may be received by the transponder of the second apparatus (e.g., second vehicle, second roadway infrastructure, etc.). In an embodiment, the second vehicle traveling along a roadway may receive an RF signal from the first vehicle as the first vehicle approaches. In an embodiment, the RF signal may include data related to a request for identification and location information relevant to the second vehicle.

In an embodiment, a method or communication process 1000 may further include a step 1006 of generating, via the transponder, a response to the signal, the response including embedded information. For example, the transponder of the second apparatus (e.g., second vehicle, second roadway infrastructure, etc.) may modulate the signal it received in order to embed additional information (e.g., approaching roadway conditions, imminent maneuvers being performed by the second vehicle, or other useful information) into a return signal to generate a response (e.g., modulated echo, modulated response, response signal, etc.) to the RF signal sent by the first apparatus (e.g., first vehicle, first roadway infrastructure, etc.).

In an embodiment, the transponder within the second vehicle may take the RF signal received from the first vehicle and prepare an echo (e.g., return signal) to reflect back to the RADAR transceiver of the first vehicle. Before transmitting the echo, the transponder may modulate the echo (e.g., via amplitude modulation, via phase modulation, via frequency modulation, etc.) in order to embed additional information (e.g., approaching roadway conditions, imminent maneuvers being performed by the second vehicle, or other useful information) to the echo, thus generating a modulated echo (e.g., modulated return signal, etc.).

In an embodiment, a method or communication process 1000 may further include a step 1008 of sending, via the transponder, the response to the RADAR transceiver. For example, the transponder of the second apparatus may transmit, via a transmission antenna within the transponder, the response (e.g., modulated echo, etc.) back to the first apparatus. In an embodiment, the transponder within the second vehicle may include a transmission antenna configured to transmit signals and an antenna configured to receive signals. The transponder within the second vehicle may use the transmission antenna to send a modulated echo, generated by modulating an RF signal received, back to the RADAR transceiver that sent the RF signal. In so doing, the transponder may be transmitting, via the transmission antenna of the transponder, the location information in response to the inquiry within the RF signal received, and also transmitting the embedded information (e.g., approaching roadway conditions, imminent maneuvers being performed by the second vehicle, or other useful information) via the modulation of the modulated echo.

In an embodiment, a method or communication process 1000 may further include a step 1010 of receiving, via the RADAR transceiver, the response and extracting the embedded information. The RADAR transceiver of the first apparatus (e.g., first vehicle, first roadway infrastructure, etc.) may receive, via the receiver antenna within the RADAR transceiver, the response (e.g., modulated echo, etc.) sent by the second apparatus (e.g., second vehicle, second roadway infrastructure, etc.). For example, the RADAR transceiver may extract the embedded information from the response, thus the first apparatus may have the location information originally requested and the additional information extracted.

In an embodiment, the RADAR transceiver within the first vehicle may include a receiver antenna configured to receive signals. The receiver antenna within the first vehicle may receive the modulated echo sent by the transponder within the second vehicle. The RADAR transponder may process the modulated echo to retrieve the location information originally requested in the RF signal and extract the additional information (e.g., approaching roadway conditions, imminent maneuvers being performed by the second vehicle, or other useful information) embedded in the modulated echo.

In an embodiment, a method or communication process 1000 may further include a step 1004 of executing, via the RADAR transceiver, one or more actions based at least in part on the embedded information. For example, by processing the extracted embedded information, the first apparatus may take action in response to the information. In an embodiment, the first vehicle may be traveling in a left lane of a highway and approaching the second vehicle traveling in the right lane of the highway. The second vehicle may embed information in the modulated echo indicating that the second vehicle intended to merge to the left lane in approximately 1 mile. The first vehicle may extract the embedded information from the modulated echo sent by the second vehicle. In response to the extracted information, the first vehicle may speed up to pass the second vehicle before the second vehicle begins to merge, the first vehicle may change lanes to provide adequate room for the second vehicle to move, or take any other appropriate action as required.

### Conclusion

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated and may include indirect connections through one or more intermediary elements. Likewise, the terms “directly” and “indirectly” describe both physical contact between components and connections made through intermediate structures, mechanisms, or devices.

What is claimed is:

1. A communication system including: a RADAR transceiver configured to be implemented in a first apparatus, a transponder configured to be implemented in a second apparatus, the first apparatus and the second apparatus configured to communicate via a method of communication, the method comprising:
sending, via the RADAR transceiver, a signal for detection of the transponder,
receiving, via the transponder, the signal,
generating, via the transponder, a response to the signal, the response including embedded information,
sending, via the transponder, the response to the RADAR transceiver,
receiving, via the RADAR transceiver, the response and extracting the embedded information, and
executing, via the RADAR transceiver, one or more actions based at least in part on the embedded information.

2. The communication system of claim 1, wherein the first apparatus is a vehicle and the second apparatus is a vehicle.

3. The communication system of claim 1, wherein the first apparatus is a vehicle and the second apparatus is a transportation infrastructure.

4. The communication system of claim 1, wherein the first apparatus is a transportation infrastructure and the second apparatus is a vehicle.

5. The communication system of claim 1, further comprising:
a second RADAR transceiver configured to be implemented in a third apparatus, and
a second transponder configured to be implemented in the third apparatus.

6. The communication system of claim 5, wherein the one or more actions based at least in part on the embedded information includes:
generating, via the RADAR transceiver, a second signal including the extracted embedded information, the second signal for detection of the second transponder;
receiving, via the second transponder, the second signal;
generating, via the second transponder, a second response to the second signal, the second response including second embedded information; and
sending, via the second transponder, the second response to the RADAR transceiver.

7. The communication system of claim 5, wherein the first apparatus is a vehicle, the second apparatus is a vehicle, and the third apparatus is a vehicle.

8. The communication system of claim 5, wherein:
at least one of the first apparatus, the second apparatus, and the third apparatus is a vehicle; and
at least one of the first apparatus, the second apparatus, and the third apparatus is a roadside infrastructure.

9. A communication system including: a cloud network, a transponder configured to be implemented into a vehicle, the cloud network and the vehicle configured to communicate via a method of communication, the method comprising:
sending, via the cloud network, a signal for detection of the transponder,
receiving, via the transponder, the signal,
executing, via the vehicle, one or more actions based at least in part on the signal,
generating, via the transponder, a response to the signal, the response including embedded information,
sending, via the transponder, the response to the cloud network, and
receiving, via the cloud network, the response and extracting the embedded information.

10. The communication system of claim 9, wherein the signal includes a software update.

11. The communication of claim 9, wherein the response includes data related to an installation status of a software update.

12. The communication system of claim 9, wherein the vehicle is a first vehicle and the transponder is a first transponder, the system further including:
a second transponder configured to be implemented into the first vehicle,
a first RADAR transceiver configured to be implemented into the first vehicle,
a second RADAR transceiver configured to be implemented into the first vehicle, and
a third transponder configured to be implemented into a second vehicle.

13. The communication system of claim 12, the method further comprising:
generating, via the first RADAR transceiver, a second signal for detection of the third transponder,
receiving, via the third transponder, the second signal,
executing, via the second vehicle, one or more actions based at least in part on the second signal,
generating, via the third transponder, a second response to the second signal, the second response including second embedded information,
sending, via the third transponder, the second response to the second transponder,
receiving, via the second transponder, the second response and extracting the second embedded information,
generating, via the second RADAR transceiver, a third signal including the second embedded information,
sending, via the second RADAR transceiver, the third signal to the cloud network, and
receiving, via the cloud network, the third signal and extracting the second embedded information.

14. The communication system of claim 13, wherein:
the signal includes a software update,
the second signal includes the software update,
the response includes first data related to a first installation status of the software update in the first vehicle, and
the second response includes second data related to a second installation status of the software update in the second vehicle.

15. A communication method, comprising:
sending, via a RADAR transceiver configured to be implemented in a first apparatus, a signal for detection of a transponder configured to be implemented in a second apparatus,
receiving, via the transponder, the signal,
generating, via the transponder, a response to the signal, the response including embedded information,
sending, via the transponder, the response to the RADAR transceiver,
receiving, via the RADAR transceiver, the response and extracting the embedded information, and
executing, via the RADAR transceiver, one or more actions based at least in part on the embedded information.

16. The communication method of claim 15, wherein the first apparatus is a vehicle and the second apparatus is a vehicle.

17. The communication method of claim 15, wherein the first apparatus is a vehicle and the second apparatus is a transportation infrastructure.

18. The communication method of claim 15, wherein the first apparatus is a transportation infrastructure and the second apparatus is a vehicle.

19. The communication method of claim 15, further comprising:
a second RADAR transceiver configured to be implemented in a third apparatus, and
a second transponder configured to be implemented in the third apparatus.

20. The communication method of claim 19, wherein the one or more actions based at least in part on the embedded information includes:
generating, via the RADAR transceiver, a second signal including the extracted embedded information, the second signal for detection of the second transponder;
receiving, via the second transponder, the second signal;
generating, via the second transponder, a second response to the second signal, the second response including second embedded information; and
sending, via the second transponder, the second response to the RADAR transceiver.
